(19) United States
(12) Patent Application Publication
(10) Pub. No.: US 2012/0107561 A1
(43) Pub. Date: May 3, 2012

(54) METHOD FOR PRODUCING DECORATIVE METALLIC ARTICLE WITH WOOD GRAIN METAL PATTERN, AND DECORATIVE METALLIC ARTICLE WITH WOOD GRAIN METAL PATTERN

(75) Inventors: Masashi Hirama, Tokyo (JP); Hidekazu Yoshihara, Tokyo (JP); Ryota Mitsuhashi, Tokyo (JP); Tomoaki Kasukawa, Tokyo (JP); Akiyoshi Yatsugi, Tokyo (JP)

(73) Assignee: AIDA CHEMICAL INDUSTRIES CO., LTD, FUCHU-SHI, TOKYO (JP)

(21) Appl. No.: 13/381,278

(22) PCT Filed: Sep. 27, 2010
(86) PCT No.: PCT/JP2010/066681

§ 371 Date: Dec. 28, 2011

(30) Foreign Application Priority Data
Sep. 27, 2009 (JP) 2009-221733
Sep. 27, 2009 (JP) 2009-221735
Sep. 30, 2009 (JP) 2009-227961
Sep. 30, 2009 (JP) 2009-227962
Sep. 30, 2009 (JP) 2009-2277963

(51) Int. Cl. B32B 15/00; B22F 7/02

(52) U.S. Cl. 428/151; 419/7

(57) ABSTRACT

Provided are a method for producing a decorative metallic article with a wood grain metal pattern and the decorative metallic article with the wood grain metal pattern; the decorative metallic article comprising a sintered copper part produced by sintering a plastic copper containing clay compound, and a sintered silver part produced by sintering a plastic silver containing clay compound. The method comprises: a plate forming step of forming a copper plate and a silver plate; a multi layering and adhesion step of mutually laminating the copper and silver plates one another by applying water to the surfaces of the plates, and elongating the laminated plates so that a thickness thereof decreases in 10% or more, thereby to adhesively paste together; a wood grain metal plate forming step of forming a wood grain pattern by carving the surface of the multi layered plate produced in the multi layering and adhesion step so as to expose at least a part of the plurality of plate layers, and elongating the surface of the multi layered plate to become flat; a decorative object forming step of forming a decorative object by using the prepared wood grain metal plate; a decorative object drying step of drying the decorative object; and a sinter producing step of sintering the decorative object produced in the decorative object drying step, thereby to obtain the decorative metallic article.

### FIELD OF THE INVENTION

The present invention relates to a method for producing a decorative metallic article with a wood grain metal pattern and the decorative metallic article with the wood grain metal pattern, used in jewelry goods, ornaments, and clothing accessories or the like; the decorative metallic article comprising a sintered copper part produced by sintering a plastic copper clay compound including at least one kind of a copper based powder metal selected from copper or a copper alloy, and a sintered silver part produced by sintering a plastic silver clay compound including at least one kind of a silver based powder metal selected from silver or a silver alloy.

### BACKGROUND OF THE INVENTION

As a unique technique of Japanese metalworking originating in the Edo period about 400 years ago, a wood grain metal (or mokumegane) technique has been known. The wood grain metal technique comprises the steps of: diffusion-joining palates by laminating a plurality of ground metals such as copper, silver and gold having different color tones to form one sheet of a ground metal; creating a wood grain metal pattern by carving a part of the surface of the resulting ground metal by a chisel; and repeatedly performing processes to make protrusions of the surface of the grand metal flat using a hammer, thereby to form a unique pattern. Further, it is possible to color the resultant plate of the ground metal by boiling in a verdigris solution. The above mentioned wood grain metal technique (or mokumegane) mainly spread as a technique of a decorative art for decollating a samurai sword (or handguard). Today, the wood grain metal technique has been performed in countries all over the world including the USA besides Japan, yielding manufacturers such as metal craftsmen and jewelry artists. However, absolutely, it is hard to say that the wood grain metal technique itself is sufficiently known or spreads worldwide.

Here, a technique of forming a pattern by laminating a plurality of metallic plates having different color tones includes a procedure to prevent entering of oxygen (or air), in order to suppress oxidation of the metallic plates when the diffusion-joining is performed. For that purpose, the procedure comprises the steps of applying a mixture of charcoal and filling powders to peripheries of the laminated metallic plates under the laminated pressure, and heating the resultant plates.

Alternatively, several other procedures have been proposed, instead of the method for applying a mixture of charcoal and filling powders to the peripheries of the laminated metallic plates under the laminated pressure. For example, the Patent Document 1 discloses a method comprising steps of mutually laminating a copper plate with a red color, a copper alloy plate with a gold color, and a stainless steel plate with a silver color into a multistage form, surrounding the laminated metallic plates with supplement iron plates and hermetically welding a resultant product to isolate the product from the outside air, and heating the product at 800 to 850° C. in a heating furnace under the laminated pressure to be metallurgically laminated and make the plates adhere each other (that is, diffusion-joined), thereby to obtain a multi layered clad plate.

Further, the Patent Document 2 discloses an exemplary method for obtaining a plate-like clad material comprising metallic phases with different color tones on a surface thereof, the method comprising the steps of: laminating an anti-corrosion steel plate such as a stainless steel plate and a copper alloy plate with different color tones such as brass, bronze, gold-copper alloy, Abyssinian gold, Mannheim gold, and Nurnberg gold; and sealing the resultant laminated plates with enclosure steel plates by heating the plates at 800-900° C. to be diffusion-joined. More specifically, the Patent Document 2 shows that a material produced by laminating stainless steel plates and gold-copper plates is surrounded by thin steel plates with 5 mm thickness to be sealed, and a plate-like clad material is obtained by heating the resultant product at 800° C. in a heating furnace, and then rolling it. As another example, the Patent Document 2 discloses that a stainless steel plate and an Abyssinian gold plate with a composition of Cu in 86.4%, Zn in 11.2%, Sn in 1.4% and Au in 0.1% are laminated, and the resultant product is surrounded by thin steel plates of 5 mm thickness to be sealed, put in a heating furnace to be heated at 850° C., and rolled to obtain a plate-like clad material. Further, is also disclosed that a stainless steel plate and an aluminum gold plate with a composition of Cu in 96%, Al in 5% and Fe in 1% are laminated, and the resultant product is surrounded by thin steel plates of 1 mm thickness to be sealed, put in a heating furnace to be heated at 800° C., and rolled to obtain a plate-like clad material.

Similarly, the Patent Document 3 discloses that an anti-rust metallic plate such as a ferrite based or an austenite based stainless steel, and a decorative metallic plate such as a Cu—Zn alloy based plate, a Cu—Sn alloy based plate, a Cu—Au alloy based plate and Cu—Al alloy based plate, are laminated, and joints of junction are sealed by a method such as hermetical welding (in Example section, thin steel plates with 5 mm thickness surround and seal the joints). Then, the resultant product is put in a heating furnace in the condition preventing the outside air from penetrating therein, to be heated up to 800 to 900° C. for conducting the diffusion-joining.

Further, the Patent Document 4 discloses that a steel plate of which predetermined surface is plated by tin or zinc, is laminated with a copper or copper alloy plate, and the resulting product is heat-rolled in the condition preventing the outside air from penetrating through joint peripheries thereof, to diffusion-join the resultant product at a low temperature around a melting point of the plating metal. More specifically, it is disclosed that copper plates are laminated on both sides of a steel plate of which surface is plated with tin. The resulting product is surrounded by thin steel plates with 1 mm thickness, and joint parts thereof are hermetically welded. The resultant product is put in a heating furnace to be heated at 200° C., and then rolled to obtain a composite plate. Further, it is also disclosed that brass plates are laminated on both sides of a steel plate of which surface is plated with zinc, and the resultant product is covered by thin steel plates with 1 mm thickness, hated at about 450° C., and then rolled to obtain a composite plate.

Of methods using a plastic composition containing a precious metallic powder, a method disclosed in the Patent Documents 5 to 7 is proposed to create a metallic article produced by joining different metallic sinters. Note that the Patent Documents 5 to 7 describe that copper is included in precious metals. However, copper has a disadvantageous property that an anti-corrosion profile (or anti-oxidation profile) of copper is greatly inferior to that of general precious metals such as gold, silver and platinum. In other words, copper or a copper alloy has a property that copper or a copper alloy is oxidized when copper or a copper alloy is heated in the oxidation atmosphere (or in the air).

The Patent Document 5 discloses a method comprising the steps of: forming “plastic clay compounds each containing a precious metallic powder” in a plate shape, which turn to different colors by sintering, laminating a plurality of plate shaped products, rolling up a resultant lamination into a roll shape, cutting off the resultant product, and sintering the cut materials.

A procedure described in the Patent Document 6 comprises the steps of: forming a plastic clay compound containing the first precious metallic powder in a plate shape, removing a plate part at the desired region, cramming a plastic clay compound containing the second precious metallic powder showing a different color into the removed plate part, and sintering the resultant product.

A procedure of the Patent Document 7 is a method comprising the steps of: pre-forming a plurality of plastic precious metal clay compounds in a block or plate shape, which turn to different colors by sintering, joining the resulting products so that the patterns at front and rear sides thereof become different, and sintering the resulting product.

However, the every technique described in the Patent Documents 5 to 7 is a method for joining the plastic clay compound in a so-called clay-like state capable of being plastically deformed, in a rough combination manner. In short, the technique is greatly restricted in designing because various patterns have to be expressed using the plastic clay compound in the clay-like state. Further, every technique in the Patent Documents 1 to 3 provides only a decorative metallic article which lacks sharp appearance of the pattern compared to the decorative metallic article obtained by the wood grain metal technique, resulting in a total failure to express the pattern created by the wood grain metal technique.

Further, the Patent Documents 5 to 7 do not sufficiently and clearly describe the sintering conditions. Particularly, the Patent Document 7 does not describe any of the atmosphere condition in the sintering process.

The patent Documents 5 and 6 describe methods that a plastic clay compound containing a pure gold powder is sintered in the air, that is, in the oxidation atmosphere, while a plastic clay compound containing a so-called K18 alloy made by mixing gold in 75.0 wt %, silver in 12.5 wt % and copper in 12.5 wt % is sintered in the argon atmosphere. In other words, it is disclosed that even though the plastic clay compound containing the K18 alloy slightly containing copper only in 12.5 wt % is used, the sintering process thereof has to be conducted in the inert atmosphere.

However, even though both Patent Documents 5 and 6 propose a method that plastic clay compounds containing metallic powders with different color tones are sintered in the physically joined state, there is no description what sintering conditions should be used in the state that a plastic clay compound A containing a pure gold powder to be sintered in the oxidation atmosphere is joined with a plastic clay compound B containing copper such as a K18 alloy to be sintered in the inert atmosphere.

Furthermore, according to a reference document issued by the applicant of the Patent Documents 5 to 7, in order to sinter a shaped object made from the plastic clay compound containing powder of bronze which is a copper alloy including tin, a method is described that a shaped bronze object is placed on a bed of a reduction agent such as charcoal applied on an aluminum foil, and the shaped bronze object is covered by a stainless steel vessel and heated up to 860° C. for about 1 to 3 hr to sinter the shaped object.

### PRIOR ART DOCUMENTS

### Patent Literatures

[Patent Document 1] Japanese Patent Application Publication No. S57-4434
[Patent Document 2] Japanese Patent Application Publication No. S55-36031
[Patent Document 3] Japanese Patent Application Publication No. S55-1986
[Patent Document 4] Japanese Patent Application Publication No. S34-6416
[Patent Document 5] Japanese Patent No. 2932648
[Patent Document 6] Japanese Patent No. 2924139
[Patent Document 7] Japanese Patent No. 3389613

### DISCLOSURE OF THE INVENTION

### Problems to be Solved by the Invention

However, a wood grain metal technique is a high-grade and special chasing method that needs significant efforts to master. Further, it is required to prepare a condition in the reduction atmosphere. Accordingly, the wood grain metal technique is not a method at all to be mastered at a further education school or the like.

Further, according to a procedure described in the Patent Document 1, a plurality of laminated metallic plates are covered with supplemental iron plates, to be hermetically welded so as to isolate the resulting product from the outside air. Herein, an operation of covering the metallic plates with the supplemental iron plates in the state of pressuring the plurality of metallic plates, requires the extremely difficult operational technique. Together with this, hermetical welding requires a high-grade skill. Accordingly, the conventional wood grade metal technique requires special equipment and devices as well as a high-grade skill.

Similarly to the above mentioned procedure, in the procedures described in the Patent Documents 2 to 4, a plurality of metallic plates are isolated from the outside air by surrounding peripheral parts of the plurality of metallic plates with thin steel plates and hermetically welding the resulting product. Similarly to the Patent Document 1, an operation of covering the metallic plates with the supplemental iron plates in the state of pressuring the plurality of metallic plates, requires extremely difficult operational technique. Together with this, hermetical welding also requires a high-grade skill. Accordingly, the conventional wood grain metal technique requires special equipment and devices as well as a high-grade skill.

Further, decorative metallic articles produced by the techniques described in the Patent Documents 5 to 7 do not reach at all a decorative metallic article obtained by the above mentioned wood grain metal technique, in comparison with each other.
Moreover the Patent Document 5 describes a procedure comprising the steps of: laminating two kinds of plastic clay compounds each as a plate-like shape, rolling up the resulting product to a roll-like shape, cutting off the roll-like shaped product, and sintering the cut off materials. The procedure might look a wood grain metal “like” technique. However, the finally obtained decorative article is a product only produced by the steps of: laminating the plate-like compositions, rolling up the laminate to the roll shaped object, cutting off the roll shaped object in the clay-like state to pieces, and sintering the cut off pieces. Therefore, when compared to the decorative metallic article obtained through the wood grain metal technique, the above mentioned product lacks sharpness of the pattern thereof, thereby not to reach at all the decorative article representing a pattern produced by the wood grain metal technique, resulting in the production of a severely simple metallic article.
Furthermore, as mentioned hereinbefore, sintering conditions of the plastic copper clay compound containing at least one kind of a copper based powder metal selected from copper and a copper alloy, have been known to be basically performed in the inert atmosphere, that is, in the reduction atmosphere. In contrast, what conditions or procedures should be used to obtain a decorative metallic article by sintering a composite shaped object without damaging the shaping of the object, have not been known specifically, when a composite shaped object produced by joining a plastic copper containing clay compound with a plastic precious metal containing clay compound including a precious powder metal such as silver, which has an anti-oxidation profile not oxidized in the air in the sintering process.

From the viewpoint of the drawbacks as mentioned above, the present inventors have investigated to provide a method for producing a decorative metallic article, and the decorative metallic article, used in jewelry goods, ornaments and clothing accessories or the like, the decorative metallic article being produced by joining a plastic copper containing clay compound including at least one kind of a copper based powder metal selected from copper or a copper alloy having a variety of colors such as a brown color of copper, a bronze color, and a nickel color of a copper and nickel alloy, with a plastic silver clay compound containing at least one kind of a silver based powder metal selected from silver or a silver alloy. Accordingly, the present invention is finally realized.

Herein, an object of the present invention is to provide a method for producing a decorative metallic article with a wood grain metal pattern (or mokumegane pattern) comprising a sintered copper part produced by sintering a plastic copper containing clay compound and a sintered silver part produced by sintering a plastic silver containing clay compound.

### Means for Solving the Problems

Here, a method for producing a decorative metallic article with a wood grain metal pattern in the first aspect of the present invention comprises:

[Plate forming Step] of forming a plastic copper containing clay compound including an organic binder and at least one kind of a copper based powder metal selected from copper and a copper alloy, and a plastic silver containing clay compound including an organic binder and at least one kind of a silver based powder metal selected from silver and a silver alloy, each formed in a plate-like shape, thereby to produce a copper plate and a silver plate;

[Multi Layering and Adhesion Step] of laminating the copperplate and the silver plate one another by applying water to the joint parts thereof, and adding a load to the resulting laminate to elongate the laminated plates so as to reduce a thickness thereof in 10% and more, thereby to adhesively paste the plates together;

[Wood Grain Metal Plate Forming Step] of carving a surface of the multi layered plate to expose at least a part of the copper plates and the silver plates after produced in the [Multi Layering And Adhesion Step], and elongating the carved surface of the multi layered plate to become flat, thereby to form a wood grain metal pattern;

[Decorative Object with Wood Grain Metal Pattern Forming Step] of forming a decorative object by using the wood grain metal plate after formed (that is an undried decorative object with a wood grain metal pattern; hereinafter, referred to as only “Decorative Object”);

[Decorative Object Drying Step] of drying the decorative object with a wood grain metal pattern after formed; and

[Sinter Producing Step] of obtaining a decorative metallic article by sintering the dried decorative object with a wood grain metal pattern produced in the [Decorative Object Drying Step].

According to the method for producing the decorative metallic article with such a wood grain metal pattern, the method comprises steps of: forming the copper plate and the silver plate respectively by the plastic copper containing clay compound and the plastic silver containing clay compound; mutually laminating the plates one another; elongating the laminated plates by adding a load to adhesively paste together; carving the surface of the multi layered plate so as to expose at least a part of the copper plates and the silver plates; further elongating the surface thereof so that the surface becomes flat; forming the decorative object by using the resultant wood grain metal plate; drying the formed decorative object; and subsequently sintering the resulting decorative object. This method allows a decorative metallic article equal to or better than a decorative article produced by the wood grain metal technique of the traditional handcrafts to be easily obtained without mastering a high-grade and special chasing skill.

In other words, the operations of forming one sheet of a ground metal through diffusion-joining plates and flattening the resultant plate by beating it with a hammer, which need extremely dangerous and heavy labor, respectively. In contrast, the wood grain metal pattern of the present invention may be formed by the steps of: carving the surface of the multi layered plate under the soft material condition before drying the decorative article, so as to expose at least a part of the copper plates and the silver plates; elongate the carved surface so that the surface thereof becomes flat, forming a plate with a wood grain metal pattern; forming a decorative object with the wood grain metal pattern; and finally sintering the resulting decorative object thereby to produce a decorative object sinter. Therefore, the method of the present invention allows the wood grain metal pattern to be formed under the soft material condition, delicate handling to be achieved without a large strength (or labor), and the decorative object sinter to be very easily obtained. Thus, in spite of the very easy production method, the method can combine the wood grain metal pattern equal to or more than the pattern produced by the wood grain metal pattern technique of the traditional handcrafts.

Further, the [Multi Layering and Adhesion Step] comprises not only laminating and pasting plates simply, but laminating the copper plate and the silver plate one another by applying water to the surfaces thereof, and then elongating the laminated plates to reduce the thickness in 10% or more, thereby to adhesively paste the laminated plates together. This allows a multi layered cross-section of the decorative object to comprise a densely fine appearance and prevent separation of the multi layers each other in the following step, thereby to form a gorgeous wood grain metal pattern on the decorative metallic article.

In contrast, the Patent Document 5 discloses a method for obtaining a metallic article, comprising the steps of: laminating a plurality kinds of plastic clay compounds as a plate formed respectively, containing precious powder metals which respectively turn to different color tones by sintering as mentioned hereinbefore; rolling up these plates to produce a roll-shape mixed object; cutting off the roll-shape mixed object in the clay-like state so as to expose respective plastic clay compounds, and sintering the resultant cut off mixed object to be solidified, thereby to obtain a metallic article.

However, the Patent Document 5 discloses a method including no operations of: “laminating the plates one another by applying water to each joint surface of the plates; adding a load on the laminated plates; and elongating the laminated plates by rolling these plates by a roller or the like so as to reduce the thickness of the laminated plates in 10% or more” conducted in the multi layering and adhesion step of the present invention. This method results in likely causing separation between the layers, thereby to be a completely different method form that of the present invention. Hereby, the Patent Document 5 discloses a method comprising steps of only forming a roll shape cross-section of the product, and simply rolling up the plurality of plates. Accordingly, the cross-section of the resulting product is hardly recognized to have a wood grain metal pattern, and only appears as a roll cake structure, resulting in an ultimately insipid decorative article as an art craft.

Here, the terms “water” applied to the joint surfaces of the copper plate and the silver plate may be simple “water”, as well as any materials which may be usable as long as the material causes no defect of the adhesion of the joint surfaces as the material is moistened with water. The aspect of the “water” may include a paste containing copper-silver mixed powder (that is, a water soluble paste-like composition of including a copper powder and a silver powder, and an organic binder), a water soluble paste containing copper powder, and a water soluble paste containing silver powder. Such a paste can be used because the paste contains “water”.

Further, the terms “carving” in the description that “by carving the surface of the multi layered plate so as to expose at least a part of the copper plates and the silver plates” in the [Wood Grain Metal Plate Forming Step] mean at least “cutting”, “gouging”, “shaving”, “scraping off”, and “scraping away” or the like in the present invention, thereby to be most broadly interpreted.

Similarly, the terms “elongating” in the description that elongating the carved surface of the multi layered plate to become flat, thereby to form a wood grain metal pattern” in the [Wood Grain Metal Plate Forming Step] mean at least “extending”, “spreading”, and “rolling” or the like in the present invention, thereby to be most broadly interpreted.

The dried decorative object with a wood grain metal pattern may be sintered in either the atmosphere of the reduction atmosphere or the oxidation atmosphere. When a decorative object is sintered in the reduction atmosphere, a complicated procedure is required, comprising the steps of: continuously flowing the inert gas such as argon gas or nitrogen gas, and putting a reduction agent such as charcoal together with the decorative object in a sealed vessel so as to heat the mixture in the vessel from the outside. Thus, the decorative object is preferably sintered in the oxidation atmosphere (or sintered in the air). In order to sinter the decorative object in the oxidation atmosphere, preferably at least one kind of a copper powder metal selected from copper and a copper alloy included in the plastic copper clay compound, may be particularly limited to the copper powder with a mean particle diameter of 10 μm or less. Further, after burning and removing the organic binder included in the clay compound in the air firing, it is preferable to additionally sinter the silver powder and the copper powder tightly in the reduction atmosphere. This allows a multi layered cross-section of the decorative object to comprise a densely fine appearance and prevent separation of the multi layers each other, thereby to form a gorgeous wood grain metal pattern on the decorative metallic article, together with, to need no pickling treatment because the amount of the oxidation film on the surface of the decorative object is extremely small.

Note the above mentioned terms “silver alloy” of the present invention mean an alloy of which silver content is 80 wt % or more including, for example, silver of grade 950, grade 925, grade 900 and grade 800 authorized by the Japan Quality Authorization System. Such a “silver alloy”, for example, includes a silver-Pd alloy or the like, of which sulfurization resistance performance is improved. Note the silver alloy containing no silver oxide is preferable. Hereby, it is possible to prevent the resultant sinter from becoming a porous product by containing no silver oxide in the silver alloy.

On the other hand, the above mentioned terms “copper alloy” of the present invention mean an alloy of which copper content is 80 wt % or more including, for example, bronze, gunmetal and a copper-nickel alloy or the like. Note the copper alloy containing no copper oxide is preferable. Hereby, it is possible to prevent the resultant sinter from becoming a porous product by containing no copper oxide in the copper alloy.

Herein, according to the present invention, the terms “air sintering” mean that the sintering process is conducted in the air, and identical to the sintering process conducted in the oxidation atmosphere. Further, the terms “reduction atmosphere” are construed as an inside state of a sealed vessel in which a reduction agent such as charcoal (that is, an agent tends to be more easily oxidized than the shaped copper object in the heating process) is put together with the shaped copper object, and the mixture in the sealed vessel is heated from the outside. Thus, the terms “reduction atmosphere” are construed as identical to the inert atmosphere such as the argon gas atmosphere, and include such atmosphere.

According to the second aspect of the present invention, a method for producing a decorative metallic article with a wood grain metal pattern includes the processes of: laminating the copper plate and the silver plate by applying water to the joint surfaces thereof; adding a load onto the laminate to elongate a thickness of the laminated plates to be reduced in 10% or more; adhesively pasting the laminated plates together to form a copper-silver plate; cutting or folding back the copper-silver plate; laminating the resultant copper-silver plates by applying water to the joint surfaces, then, adding a load onto the resulting laminate to elongate a thickness of the laminated plates to be reduced in 10% or more, thereby to obtain a multi layered copper-silver plate; further repeatedly conducting the abovementioned operations at least one time, finally to form the multi layered copper-silver plate.

According to the second aspect of the present invention, the method for producing the decorative metallic article with the wood grain metal pattern, the multi layered plate obtained in the [Multi Layering and Adhesion Step] comprises extremely a number of layers, and a thickness of each layer may be elongated uniformly, allowing a more gorgeous wood grain metal pattern to be formed.

According to the third aspect of the present invention, a method for producing a decorative metallic article with a wood grain metal pattern comprises a step of elongating the laminated plate so that a thickness of the laminated plate is reduced in 20 to 80%, thereby to adhesively paste the multi layers of the laminated plate each other.

According to the third aspect of the present invention, the method for producing the decorative metallic article with the wood grain metal pattern allows a more densely fine and gorgeous wood grain metal pattern to be formed.

According to the fourth aspect of the present invention, a method for producing a decorative metallic article with a wood grain metal pattern comprises a step of forming a ring with a wood grain metal pattern by shaping a wood grain metal plate into a ring shape in the [Decorative Object Forming Step].

According to the fourth aspect of the present invention, the method for producing the decorative metallic article with the wood grain metal pattern allows a ring and a bracelet having a densely fine and gorgeous wood grain metal pattern to be easily produced.

According to a fifth aspect of the present invention, a method for producing a decorative metallic article with a wood grain metal pattern comprises a step of drying a multi layered decorative object by natural drying or heat drying at a drying temperature of 80 to 180° C. and in a drying time of 10 to 60 min in the [Decorative Object Drying Step].

According to the fifth aspect of the present invention, the method for producing the decorative metallic article with the wood grain metal pattern, the heat drying process can be conducted by a drying machine, an electric furnace or a dryer or the like. The heat drying process is preferably conducted at a drying temperature of 80 to 120° C. and in a drying time of 20 to 40 min.

The completion of the drying process is preferably a state that no steam is emitted from the dried decorative abject when heated at 80 to 120° C. The drying completion may be confirmed by determining whether dew concentrates or not on a glass plate or a stainless steel plate, when the dried decorative abject heated at 80 to 120° C. is put close to the glass plate or the stainless steel plate. If the dew is not concentrated, the drying process may be regarded as completed.

Note the drying process may be conducted by natural drying, and in that case, drying for one day or more is particularly preferable. The completion of drying may be determined that dew is not concentrated by heating the object with a dryer or the like as mentioned above.

According to a sixth aspect of the present invention, a method for producing a decorative metallic article with a wood grain metal pattern comprises the steps of: taking out the decorative object from a heating source immediately after the temperature of the air firing reached 350 to 450° C. from room temperature; heating the resulting decorative object up to 700 to 800° C. from room temperature to be sintered in the reduction atmosphere; and subsequently keeping the temperature for 30 min to 9 hr.

According to the sixth aspect of the present invention, the method for producing the decorative metallic article with the wood grain metal pattern comprises steps of: burning and removing the organic binder included in the clay compound in the air firing, and subsequently sintering the silver powder and the copper powder tightly in the reduction atmosphere. This allows a multi layered cross-section of the decorative object to comprise a densely fine appearance and prevent separation of the multi layers each other, thereby to form a gorgeous wood grain metal pattern on the decorative metallic article, together with, to need no pickling treatment because the amount of the oxidation film on the surface of the decorative object is extremely small.

Note a specific method for sintering in the reduction atmosphere is not particularly limited. However, for example, the decorative object may be sintered in the reduction atmosphere, by sintering it in a sealed heat-resistant vessel (for example, stainless-steel vessel or altaite vessel) with charcoal.

According to the seventh aspect of the present invention, a method for producing a decorative metallic article with a wood grain metal pattern, in the above mentioned first or second aspect, the air sintering is conducted in the whole [Sinter Producing Step].

According to the seventh aspect of the present invention, the method for producing the decorative metallic article with the wood grain metal pattern comprises a step of sintering in the air. Accordingly, the decorative object is not sintered in the reduction atmosphere as a conventional procedure. Hereby, this may avoid complicated procedures of: flowing the inert gas such as argon gas and nitrogen gas continuously, and putting a reduction agent such as charcoal together with the dried decorative object in a sealed vessel so as to heat the mixture in the vessel from the outside. The above mentioned advantages facilitate the method for producing a decorative metallic article to be more easily applied in a further education school or the like.

According to the eighth aspect of the present invention, a method for producing a decorative metallic article with a wood grain metal pattern comprises a step of sintering the decorative object at a sintering temperature of 660 to 770° C. and in a sintering time for 3 to 40 min, in the [Sinter Producing Step].

According to the eighth aspect of the present invention, in the method for producing the decorative metallic article with the wood grain metal pattern, it is particularly preferable to conduct the sintering process at a lower temperature and in a shorter time than the temperature and time of sintering singly the shaped copper object or singly the shaped silver object.

When the decorative object is sintered in the air, an electric furnace may be pre-heated in advance at the sintering temperature, and the decorative object may be put into the electric furnace kept at the sintering temperature, and then, after keeping the temperature at the predetermined temperature for a determined length of time to complete the sintering process. Finally, the decorative object may be taken out from the electric furnace thereby to be rapidly cooled.

According to the ninth aspect of the present invention, in a method for producing a decorative metallic article with a wood grain metal pattern,

at least one kind of a copper based powder metal selected from copper and a copper alloy included in the copper containing clay compound is a mixed copper powder consisting of a first copper powder with a mean particle diameter of 0.1 to 4.0 μm in 25 to 75 wt %, and the remainder of a second copper powder with a mean particle diameter in the range from more than 4.0 μm to 10 μm or less, and

at least one kind of a silver based powder metal selected from silver and a silver alloy included in the silver containing clay compound is a mixed silver powder consisting of a first silver powder with a mean particle diameter of 0.1 to 4.0 μm in 25 to 75 wt %, and the remainder of a second silver powder with a mean particle diameter in the range from more than 4.0 μm to 40 μm or less.

According to the ninth aspect of the present invention, in the method for producing the decorative metallic article with the wood grain metal pattern, at least one kind of the copper based powder metal selected from copper and a copper alloy included in the copper containing clay compound is limited to the copper based powder of which mean particle diameter is 10 μm or less. Further, the powders included in the copper containing clay compound and the silver containing clay compound are made as specific mixed powders having different mean particle diameters respectively. Then, the copper containing clay compound is joined with the silver containing clay compound to conduct steps of shaping, forming a wood grain metal pattern and drying to form a multi layered decorative object having a wood grain metal pattern. Note even though the resulting decorative object is sintered in the air at the predetermined sintering temperature and in the predetermined time, the decorative object can be sintered without “damaging” the shaping, which allows a copper plate sintering part (or shaped copper sinter part) and a silver plate sintering part (or shaped silver sinter part) to have steady strength required for a sintered article for the craft or decorative use.

Each of those copper containing clay compound and silver containing clay compound includes specific mixed powders with different particle diameters. This allows the coefficient of linear contraction of each shaped object after sintering to be suppressed at a similarly low level, resulting in no peeling and no damaging of the shape of the sinters after sintering, since the contraction of one decorative sinter is not so greatly larger than that of the other decorative sinter.

Here, even though the surface of the copper plate sinter part is very slightly oxidized in the air sintering, the inside part of the copper plate sinter part is not affected by the oxidation. Accordingly, this facilitates an oxidation film formed on the surface of the copperplate sinter part to be very easily detached, allowing the appearance of the copper plate sinter part to be sufficiently accepted as a sintered article for craft or decorative use. Note there is a rare case that it is preferable to sinter the shaped silver object in the reduction atmosphere depending on a silver alloy component included in the plastic silver containing composition, with respect to the shaped silver sinter part. However, in general, if the shaped silver object may be sintered in the air, the sintering thereof may be performed without any problem.

Therefore, the shaped object is not sintered in the reduction atmosphere as a conventional procedure. Hereby, this may avoid complicated procedures of flowing the inert gas such as argon gas and nitrogen gas continuously, and putting a reduction agent such as charcoal together with the dried decorative object in a sealed vessel so as to heat the mixture in the vessel from the outside. The above mentioned advantages facilitate the method for producing a decorative metallic article to be more easily applied in a further education school or the like.

Further, in the present invention, the copper containing clay compound is joined with the silver containing clay compound to form the dried decorative object, and the resulting decorative object is simultaneously (or all at once) sintered in the air. This avoids the sintering equipment to be used numerous times, resulting in the extremely efficient method.

Here, the terms “mean particle diameter” of the copper powder, the copper alloy powder, the silver powder and the silver alloy powder used in the present invention are also referred to as an average grain diameter, an average particle diameter, a median diameter, a median size, or a 50% particle size; are typically represented as “D50”; and mean a particle size corresponding to 50% of a cumulative distribution curve. More specifically, the mean particle diameter is a value of D50 of a particle size distribution obtained by using a laser diffraction-type particle size distribution measurement device with tri-laser scattered light detection mechanism (manufactured by Microtrac, Inc.) and setting measurement conditions thereof at [particle permeability: reflection] and [spherical/nonspherical: nonspherical] (that is, when the particle permeability is set to reflection and the selection of spherical/nonspherical is set to nonspherical).

According to the tenth aspect of the present invention, a decorative metallic article with a wood grain metal pattern is produced by the production method described in the first or second aspect.

According to the tenth aspect of the present invention, the decorative metallic article with the wood grain metal pattern shows a clear contrast of the color tones between the copper sinter made from the copper containing clay compound comprising various color tones including a brown color of copper, a bronze color of a copper-tin alloy, a white color of a copper-nickel alloy, and the silver sinter made from the silver containing clay compound comprising various color tones such as silver white and silver colors. Further, the decorative metallic article with the wood grain metal pattern represents a complex wood grain metal pattern equal to or better than the decorative article produced by the wood grain metal technique of the traditional handcrafts. This allows the appearance of the decorative metallic article to be sufficiently attractive as jewelry goods, ornaments, and clothing accessories or the like, whereby the decorative metallic article may become well accepted as a sintered article for craft or decorative use.

### Advantageous Effects of the Invention

According to the method for producing the decorative metallic article with the wood grain metal pattern of the present invention, the method comprises the steps of: forming the copper plate and the silver plate respectively by the plastic copper containing clay compound and the plastic silver containing clay compound; laminating the plates to one another; elongating the laminated plates by adding a load to adhesively paste together; further elongating the laminated plate after carving the surface of the laminated plate so as to expose at least a part of the copper plates and the silver plates. Then, the method further comprises the steps of: forming the decorative object using the wood grain metal plate thus obtained; and sintering the resulting object after drying the formed decorative object. Accordingly, a decorative metallic article equal to or better than the decorative metallic article produced by the wood grain metal technique of the traditional handcrafts, may be obtained.

Further, the cross-section of the decorative object sinter becomes so densely fine as causing no separation of the layers to each other, thereby to form a gorgeous wood grain metal pattern. Moreover, it is possible to freely and easily select the shaping and pattern of the decorative article in the method of the present invention, compared to the method of the Patent Document 5 that only forms a roll-cake shaped decorative article. The above mentioned advantages provide particularly excellent feature with the method of the present invention.

Further, according to the second aspect of the present invention, the method for producing the decorative metallic article with the wood grain metal pattern is capable of forming the multi layered plate with really many layers, and elongating the multi layered plate to have the thickness of each layer uniform, which allows a more beautiful wood grain metal pattern to be formed.

### BRIEF DESCRIPTION OF THE DRAWINGS

FIG. 1 is a perspective diagram schematically showing a copper plate obtained in the plate forming step in the illustrated example.

FIG. 2 is a perspective diagram schematically showing a silver plate obtained in the plate forming step in the illustrated example.

FIG. 3 is a perspective diagram schematically showing a copper-silver plate mutually adhering, obtained in the multi layering and adhesion step in the illustrated example.

FIG. 4 is a perspective diagram showing a state that a surface of the multi layered plate is carved so as to expose a part of the copper plate and the silver plate, produced in the wood grain metal plate forming step in the illustrated example.

FIG. 5 is a perspective diagram schematically showing a plane used for carving the surface of the multi layered plate in the illustrated example.

FIG. 6 is a perspective diagram schematically showing a tip portion of the plane used for carving the surface of the multi layered plate in the illustrated example.

FIG. 7 is a perspective diagram schematically showing a wood grain metal plate obtained in the wood grain metal plate forming step in the illustrated example.

FIG. 8 is a perspective diagram schematically showing a state that the wood grain metal plate is rolled up to a wood shaft to be dried, produced in the decorative object with a wood grain metal pattern forming step in the illustrated example.

FIG. 9 is a perspective diagram schematically showing a ring shaped decorative metallic article produced in Example 1.

FIG. 10 is a perspective diagram schematically showing a ring shaped decorative metallic article produced in Example 2.

### BEST MODE FOR CARRYING OUT THE INVENTION

First, a plastic copper containing clay compound and a plastic silver containing clay compound of the present invention will be explained.

The plastic copper containing clay compound includes an organic binder and at least a copper based powder metal selected form copper and a copper alloy.

Further, the plastic silver containing clay compound includes an organic binder and at least a silver based powder metal selected form silver and a silver alloy.

Herein, the copper containing clay compound preferably used is at least one kind of a copper based powder metal selected form copper and a copper alloy, comprising an organic binder and a mixed copper powder consisting of a first copper powder with a mean particle diameter of 0.1 to 4.0 μm in 25 to 75 wt %, and the remainder of a second copper powder with a mean particle diameter in the range from more than 4.0 μm to 10 μm or less.

Further, the silver containing clay compound preferably used is at least one kind of a silver based powder metal selected form silver and a silver alloy, comprising an organic binder and a mixed silver powder consisting of a first silver powder with a mean particle diameter of 0.1 to 4.0 μm in 25 to 75 wt %, and the remainder of a second silver powder with a mean particle diameter in the range from more than 4.0 μm to 40 μm or less.

As mentioned hereinbefore, various color tones of copper based metals have been well known, for example, copper has a brown color, and copper alloys have a bronze color of a copper-tin alloy, a white color of a copper-nickel alloy.

Further, silver has a silver white color. Additionally, silver alloys may be used including, for example, silver of grade 950, grade 925, grade 900 and grade 800 authorized by the Japan Quality Authorization System as mentioned hereinbefore, and a silver-Pd alloy in which Pd in 1% is added.

Manufacturing methods of those copper powder, copper alloy powder, silver powder, and silver alloy powder are not particularly specified, and may include gas atomization and reduction methods. Of the aforementioned methods, a method for manufacturing substantially spherical particles is preferably utilized.

The shaped decorative object by joining the plastic copper containing clay compound and the plastic silver containing clay compound each including a specific mixed powder containing different mean particle diameters as mentioned hereinbefore, may be sintered in the air. Hereby, the shaped copper sinter part and the shaped silver sinter part may be obtained, respectively having steady strength required for craft or decorative use. Further, the contraction of each sinter (or shaped sinter part) after the sintering process may be approximately close, allowing the decorative object sinter to avoid peeling and damaging of the shape after the sintering process, because one of the sinters is not more largely contracted than the other sinter.

Further, even though the surface of the shaped copper sinter part is very slightly oxidized in the air sintering, the inside part of the shaped copper sinter part is not affected by the oxidation. Accordingly, this facilitates the oxidation film formed on the surface of the shaped copper sinter part to be easily removed by the rapid cooling, pickling, and polishing treatments. Hereby, these removing treatments of the oxidation film allow the appearance of the shaped copper sinter part to be sufficiently accepted as a sintered article for craft or decorative use.

Moreover, regarding at least one kind of the copper based powder metal selected from copper and a copper alloy and at least one kind of the silver based powder metal selected from silver and a silver alloy, preferably, the former copper powder metal may be a mixed copper powder containing a first copper powder with a mean particle diameter of 0.5 to 4.0 μm in 25 to 75 wt % and the remainder of a second copper powder with a mean particle diameter in the range from more than 4.0 μm to 10 μm or less. Further, the latter silver based powder metal may be a mixed silver powder containing a first silver powder with a mean particle diameter of 0.5 to 4.0 μm in 25 to 75 wt % and the remainder of a second silver powder with a mean particle diameter in the range from more than 4.0 μm to 30 μm or less.

Furthermore, more preferably, the mixed copper powder may contain the first copper powder with a mean particle diameter of 2.0 to 3.0 μm in 30 to 70 wt % and the remainder of the second copper powder with a mean particle diameter of 5 μm to 10 μm, and the mixed silver powder may contain the first silver powder with a mean particle diameter of 2.0 to 3.0 μm in 30 to 70 wt % and the remainder of the second silver powder with a mean particle diameter of 5 μm to 20 μm.

The aforementioned organic binder is not limited specifically. However, the organic binder may preferably include at least one member selected from the following: a cellulose-based binder such as methylcellulose, ethylcellulose, hydroxyethylcellulose, hydroxypropylcellulose, hydroxypropylmethylcellulose, and carmellose (carboxymethylcellulose), sodium carboxymethyl cellulose, potassium carboxymethylcellulose, and calcium carboxymethylcellulose; an alginic acid-based binder such as sodium alginate; a polysaccharide-based binder such as starch, dogtooth violet starch, wheat flour, British gum, xanthane gum, dextrin, dextran, and pullulan; an animal-derived binder such as gelatin; a vinyl-based binder such as polyvinyl alcohol and polyvinylpyrrolidone; an acryl-based binder such as polyacrylic acid and polyacrylate ester; and other resin-based binder such as polyethylene oxide, polypropylene oxide, and polyethylene glycol, or the like. If the cellulose-based binder is used, a water-soluble cellulose-based binder is most preferably used.

Further, the following additive may be added to the organic binder where necessary. Namely, the additive includes one or more members selected from the following: organic acid (oleic acid, stearic acid, phthalic acid, palmitic acid, sebacic acid, acetylcitric acid, hydroxybenzoic acid, lauric acid, myristic acid, caproic acid, enanthic acid, butyric acid, capric acid, citric acid); organic acid ester such as n-dioctyl phthalate and n-dibutyl phthalate (organic acid ester having a methyl group, ethyl group, propyl group, butyl group, octyl group, hexyl group, dimethyl group, diethyl group, isopropyl group, and isobutyl group); higher alcohol (octanol, nonanol, decanol); polyol (glycerin, arabite, sorbitan, diglycerin, isoprene glycol, 1,3-butylene glycol); ether (dioctyl ether, didecyl ether); lignin which may be cited as a concrete example of the reticular macromolecular substance that results from the condensation of the component unit having phenylpropane as a backbone; liquid paraffin; and oil, or the mixture thereof (for example, olive oil containing rich oleic acid), etc. The additive is added so as to improve plasticity or prevent the copper containing clay compound or the silver containing clay compound from sticking to a hand during shaping. Further, the lignin and glycerin above-cited as the additive give an appropriate level of a water retention property.

The additive also includes an anionic, cationic, nonionic, or any other surfactant. The surfactant improves miscibility between the copper or silver powder and the organic binder, and improves a water retention property.

Of the above mentioned organic binders, the water-soluble cellulose-based binder gives plasticity to the copper containing clay compound and the silver containing clay compound. The polyethylene oxide gives a high viscosity at a low concentration and increases adhesiveness in its liquid form. The sodium alginate gives an appropriate level of a water retention property, similarly to glycerin and also helps increase adhesiveness. Further, the polyacrylate ester and polyacrylic acid additionally increase adhesiveness.

As mentioned above, the water-soluble cellulose-based binder gives plasticity to the plastic copper containing clay compound and the plastic silver containing clay compound. The water-soluble cellulose-based binder includes: methylcellulose, hydroxyethylcellulose, hydroxylpropyl-cellulose, hydroxypropylmethylcellulose, sodium carboxy-methylcellulose, potassium carboxymethylcellulose, calcium carboxymethylcellulose, etc, and is used by being dissolved in water.

If the aforementioned water-soluble cellulose-based binder is used as the organic binder, the amount of the organic binder in the plastic copper containing clay compound or the plastic silver containing clay compound is preferably in the range from 0.1 to 4 wt % by the dry solids content excluding water as the solvent. In this case, if the amount of the organic binder is less than 0.1 wt %, it is difficult to obtain a homogeneous plastic copper containing clay compound or a homogeneous plastic silver containing clay compound. Further, the strength after application or drying becomes disadvantageously lowered. In contrast, if the amount of the organic binder is more than 4 wt %, the shrinkage ratio of the obtained object increases and the object tends to easily crack. Accordingly, the amount of the organic binder is preferably in the range from 0.1 to 4 wt %.

If polyethylene oxide is used, the polyethylene oxide preferably has a molecular weight from a hundred thousand to several millions and is used in the amount in the range from 0.1 to 3 wt %.

Further, if a surfactant is used, the amount thereof is preferably in the range from 0.03 to 3 wt %. If oil is used, the amount thereof is preferably in the range from 0.1 to 3 wt %.

Further, an appropriate amount of water is added to the above mentioned plastic clay compound. If the amount of added water is too small, the plastic clay compound becomes hard, resulting in difficulty in shaping, while if the amount of added water is too large, it is difficult to keep the shape of the product after shaping. Herein, the plastic copper containing clay compound and the plastic silver containing clay compound used in the present invention can be prepared as a clay-like form, a paste-like form or a slurry-like form, by adjusting the content of water.

In the preferable composition, a metallic powder is contained in 75 to 99 wt % in both clay compounds. If the content of the metallic powder is too small, the shrinkage ratio increases to obstruct the sintering process, while if the content thereof is too large, hereby the contents of the organic binder and water decrease to obstruct the shaping.

As a sintering accelerator, a powder of Bi, Se, Sb, In, Sn, and Zn or an alloy powder thereof may be added to the plastic composition.

Further, as an adhesiveness improver, a glass powder or a metallic compound powder selected from lead carbonate, lithium carbonate, zinc oxide, phosphoric acid, sodium carbonate, vanadium oxide, sodium silicate, phosphate salt, or the like may be added to the plastic composition.

Further, an organic additive may be added so as to improve the plasticity of the clay compound. The organic additive includes lignin which may be cited as a concrete example of the reticular macromolecular substance that results from the condensation of the component unit having phenylpropane as a backbone, glycerin, diglycerin, isoprene glycol, 1,3-butylene glycol, liquid paraffin, alcohols, oil, phthalic acid, n-dioctyl phthalate, n-dibutyl phthalate, and polyvinyl alcohol. Further, a surfactant and a surface-active agent may be also added where necessary.

Moreover, a metal oxide such as zirconium oxide may be added so as to prevent the deformation of the resultant product in the sintering process. That is, the addition of a metal oxide allows the sintering rate to be delayed, which results in a formation of a gas diffusion passage through which gas, generated when the organic binder burns, diffuses to the outside of the plastic composition.

Next, will be explained each step of the method for producing the decorative metallic article of the present invention to obtain the decorative object sinter, by joining the plastic copper containing clay compound with the plastic silver containing clay compound, which is described in the first aspect of the present invention; the method comprising: [Plate Forming Step], [Multi Layering and Adhesion Step], [Wood Grain Metal Plate Forming Step], [Decorative Object Forming Step], [Decorative Object Drying Step], and [Sinter Producing Step].

[Plate Forming Step]

In the step, the plastic copper containing clay compound including an organic binder and at least one kind of a copper based powder metal selected from copper and a copper alloy, and the plastic silver containing clay compound including an organic binder and at least one kind of a silver based powder metal selected from silver and a silver alloy, are respectively formed in a plate-like shape, thereby to form a copper plate and a silver plate.

In the step, the copper plate and the silver plate to be formed are produced having a substantially same size and thickness in many cases. However, it is not necessary to produce both plates with the same thicknesses. Both plates may be intentionally formed to have different thicknesses.

[Multi Layering and Adhesion Step]

In the step, the copper plate and the silver plate are laminated one another by applying water to joint surfaces of the plates, and then a load is added to the laminated plates so as to elongate the laminated plates by a roller or the like so that a thickness of the laminated plates decreases in 10% or more, thereby to adhesively paste the laminated plates.

If the above mentioned operation is not conducted, in which the copper plate and the silver plate are laminated one another by applying water to joint surfaces of the plates, and then a load is added to the laminated plates so as to elongate the laminated plates so that a thickness of the laminated plates decreases in 10% or more, a multi layered cross-section of the decorative object does not become densely fine. Further, there may be a separated layers part each other in the laminated multi layers. The above mentioned drawbacks may cause a defect in the wood grain like pattern.

Here, the terms “water” applied to the joint parts of the copper plate and the silver plate may be simple “water” as well as any materials so long as the material causes no defect on the adhesion of the joint surfaces each other as the material is moistened with water. As an aspect of the “water”, are included a water soluble paste containing a copper-silver mixed powder (that is, a water soluble paste-like composition containing an organic binder, a copper powder and a silver powder), a water soluble paste containing a copper powder, and a water soluble paste containing a silver powder. Such a paste is usable because it contains “water” therein. When such a paste is used, the composition is not particularly limited. However, a paste consisting of the copper powder and the silver powder in the rate of 3:7 by weight, with a total content of the copper powder and the silver powder against the total amount of the paste being 70 to 90 wt %, and the remainder of water and an organic binder, may be particularly preferable.

Regarding the above mentioned paste, the basis that the content rate is set in 3:7 is as follows. That is, according to the equilibrium diagram of the copper-silver system, the rate of forming the copper-silver based crystals at near a temperature of 780° C. that is a standard sintering temperature, is 30 wt % in copper (or 39.9 atomic %) and 70 wt % in silver.

In the meantime, the multi layering and adhesion step of the present invention appears similarly to the step described in the Patent Document 5 of forming plates at room temperature and laminating the plates one another, while the method in the Patent Document 5 includes no operations of: laminating the plates one another by applying water to each joint surface of the plates; adding a load on the laminated plates; and elongating the laminated plates by rolling these plates by a roller or the like so as to reduce the thickness of the laminated plates in 10% or more. Accordingly, the method in the Patent Document 5 tends to cause separation between the layers, resulting in a completely different method from that of the present invention.

Further, the multi layering and adhesion step of the present invention corresponds to operations of forming one sheet of a ground metal, through diffusion-joining plates and flattening the resultant plate by beating it with a hammer in the wood grain metal technique of the traditional handcrafts. Those operations of the diffusion-joining and the beating by a hammer are extremely dangerous and heavy labor respectively, while the multi layering and adhesion step of the present invention needs little labor so as to be extremely easily performed.

Note, in the present step, the copper plate and the silver plate mutually adhering may be laminated as either of which surface is at the surface side when the decorative article described hereinafter is produced, so long as the order of laminating the copper and silver plates is alternate. That is, for example, both surfaces may be made of the copper plates or both surfaces may be made of the silver plates. Further, of course, one of the surfaces may be made of the copper plate, and the other surface may be made of the silver plate. However, it is preferable, for example, when a decorative object is produced as a ring-like shape, that for the surface thereof touching the skin, (that is, the inside of the ring-like shaped article) a silver plate is arranged.

According to the second aspect of the present invention, in the [Multi Layering and Adhesion Step], the copper plate and the silver plate are laminated one another by applying water to the joint surfaces of the plates, and then a load is added to the laminated plates so as to elongate the laminated plates so that a thickness of the laminated plates decreases in 10% or more, thereby to form the copper-silver plate. Further, the copper-silver plate is cut off or folded back, and the resultant copper-silver plates are laminated by applying water to the joint surfaces, and then, a load is added to elongate the laminated plates so that s thickness of the laminated copper-silver plates decreases in 10% or more, thereby to adhesively paste together for obtaining a multi layered copper-silver plate. The above mentioned operation is repeated at least one time to form the multi layered plate.

Such a multi layered plate obtained in the [Multi Layering and Adhesion Step] described in the second aspect of the present invention allows the thickness of each layer of the multi layered plate to be uniformly elongated, thereby to form a more gorgeous wood grain metal pattern.

Further, according to the third aspect of the present invention, in the [Multi Layering and Adhesion Step], the laminated plates are elongated so that the thickness of the laminated plates decreases in 20 to 80%, thereby to adhesively paste together.

According to the third aspect of the present invention, the [Multi Layering and Adhesion Step] allows a more densely fine and gorgeous wood grain metal pattern to be formed.

[Wood Grain Metal Forming Step]

In the step, a surface of the multi layered plate produced in the above mentioned multi layering and adhesion step is carved so as to expose at least a part of the copper plate and the silver plate, and the carved surface of the multi layered plate is elongated to become flat, thereby to form a wood grain metal pattern.

Herein, the terms “carve” mean at least “cut”, “gouge”, “shave”, “scrape off”, and “scrape away” or the like in the present invention, and are not limited to any specific term, thereby to be most broadly interpreted.

Further, the terms “elongate” mean at least “extend”, “spread”, and “roll” or the like in the present invention, and are not limited to any specific term, thereby to be most broadly interpreted.

Note the sentence that “a surface of the multi layered plate is carved so as to expose at least a part of the copper plates and the silver plates” means that “a surface of the multi layered plate is carved along the layers of the copper plate and the silver plate mutually adhering, by using, for example, plane or the like”. By conducting the above mentioned process, for example, when the multi layered plate is carved from the copper plate side located at the top of the multi layered plate, the carving of the copper plate located at the top of the multi layers and the silver plate located under the above mentioned copper plate can expose various kinds of the surfaces of the plates as a wood grain metal pattern when looking down the multi layered plate; the surfaces of the plates including the copper plate which is not carved located at the top, the silver plate exposed by carving the copper plate located at the top, and another copper plate located at the lower layer exposed by carving the above mentioned silver plate or the like.

When the multi layered plate is carved, for example, a plane may be used. The type of the plane is not particularly limited. However, a plane of which tip portion is ring-shaped and can carve the above mentioned multi layered plate, may be used. More specifically, the plane set of aluminum metal working (ISEKYU Co., Ltd.) may be included for use.

When the multi layered plate is carved to expose at least a part of the copper plates and the silver plates, the depth for carving is not particularly limited. However, for example, the carving may be conducted so that the depth becomes equal to about a half thickness of the multi layered plate.

Further, when the carved surface is elongated to make it flat, the elongation may be conducted so that a desired thickness is obtained, as long as the thickness may have strength for maintaining a wood grain metal pattern when the decorative object is formed.

### [Decorative Object Forming Step]

In the step, a decorative object with a wood grain metal pattern is formed by using the wood grain metal plate produced in the [Wood Grain Metal Plate Forming Step].

The specific procedure for forming a decorative object by using the wood grain metal plate is not particularly limited, and various procedures may be used. A three-dimensional shaping may not be always conducted, and the decorative object may be formed in a flat shape staying as it is.

Note the Patent Document 5 discloses a method for forming a cylindrical mixed object by simply rolling up a plurality of plates. Therefore, the decorative object forming step of the present invention is not substantially performed in the Patent Document 5.

Further, in the wood grain metal technique of the traditional handcrafts, the decorative object forming step may be achieved by forming a metallic plate material after diffusion-joining plates to produce a sheet of a ground metal. It should be noted that such an operation of forming the metallic plate material requires remarkably large strength and heavy labor, compared to the operation of shaping the clay-like multi layered plate. In contrast, the decorative object forming process in the present invention requires little labor and may be performed very easily.

Herein, a specific form of the decorative article is not particularly limited. For example, such a form includes a ring, a brooch, a pendant and pierced earrings or the like.

[Decorative Object Drying Step]

In the step, the decorative object with a wood grain metal pattern is subjected to a drying process. The drying conditions are not particularly limited. However, natural drying or heat-drying at the drying temperature of 80 to 180° C. and in the drying time for 10 to 60 min is preferably used. The heat-drying may be conducted by a drying machine, an electric furnace, and a dryer or the like. The preferable conditions comprise the drying temperature of 80 to 120° C. and the drying time for 20 to 40 min.

Here, preferably, the completion state of drying means a condition that steam does not appear from the decorative object (or dried decorative object) when heated at 80 to 120° C. The steam emission, for example, can be detected by determining whether dew is concentrated on a glass plate or a stainless steel plate when the dried decorative object heated at 80 to 120° C., is put close to the glass plate or the stainless steel plate. If the dew is not concentrated, the drying process may be regarded as completed.

Note the drying process may be conducted by natural drying, and in this case, drying for one day or more is particularly preferable. The completed drying state may be determined by that dew is not concentrated when heating the object by a dryer or the like as mentioned above.

Here, where necessary, the dried decorative object with the wood grain metal pattern may be further treated by sandpaper or the like after the drying step.

[Sinter Producing Step]

In the step, the dried decorative object with the wood grain metal pattern produced in the [Decorative Object Drying Step] is sintered to obtain a decorative object sinter. As mentioned hereinbefore, the sintering process of the decorative object may be performed in the reduction atmosphere or in the air (or in the oxidation atmosphere).

When the decorative object is sintered in the air, the object is sintered at 660 to 770° C. for 3 to 40 min, and particularly preferably at 700 to 750° C. for 10 to 15 min. Note the above mentioned sintering process is conducted at a lower temperature and in a shorter time than the sintering process of the shaped object made from the plastic copper containing clay compound.

In this connection, the conditions for sintering the shaped object made from only the plastic copper containing clay compound in the air include: at 990° C. for 3 to 6 min, at 980° C. for 4 to 15 min, at 970° C. for 5 to 30 min, at 950° C. for 5 to 40 min, at 850° C. for 10 to 50 min, and at 800° C. for 30 to 60 min as standard conditions, if the plastic copper containing clay compound of which component powder consists of pure copper. Preferably, the sintering temperature is 850 to 980° C., and more preferably 950 to 970° C.

Further, when the decorative object is sintered in the air, an electric furnace may be pre-heated at the above mentioned temperature, and the decorative object may be put in the electric furnace of which temperature is kept at the above mentioned temperature, then, the predetermined temperature may be maintained for the predetermined time, and finally the decorative object sinter may be taken out from the electric furnace, thereby to be rapidly cooled. In such a case, since the sintering process of the present invention is not conducted in the reduction atmosphere as conducted in conventional techniques, this may avoid complicated procedures of continuously flowing the inert gas such as argon gas or nitrogen gas, and putting a reduction agent such as charcoal together with the dried decorative object with the wood grain metal pattern in a sealed vessel so as to heat the mixture in the vessel from the outside. The above mentioned advantages allow the method for producing the decorative metallic article to be more easily applied in a further education school or the like.

Furthermore, of course, it is needless to say that the shaped object can be sintered in the reduction atmosphere at the same temperature as mentioned above. In such a case, preferably, it is better to have the sintering temperature higher and the sintering time longer. Moreover, for example, the shaped object may be fired in the air to burn the organic binder at the first half stage, and then the sintering in the reduction atmosphere may be conducted at the latter half stage. In such a case, for example, when the temperature of the first half stage conducting the firing in the air reaches 350 to 450° C. from room temperature, the decorative object is immediately taken out from a heating source such as an electric furnace, and the resulting object is put into a sealed stainless steel vessel together with a reduction agent such as charcoal. Then, the sealed vessel is put in the electric furnace to heat it from room temperature to 700 to 800° C. Subsequently, the temperature is kept for 30 min to 9 hr, allowing the decorative object to be sintered in the reduction atmosphere.

In the sintering process under the argon atmosphere, the sintering process is conducted by flowing argon gas in the electric furnace to prevent the air from entering the furnace.

[Surface Oxidation Film Removing Step]

This step is not necessarily needed. However, when the whole [Sinter Producing Step] is conducted in the air sintering, it is preferable to conduct this step. In the step, an oxidation film on the surface of the decorative object sinter is to be removed by rapid cooling, pickling and polishing treatments or the like.

The rapid cooling, pickling and polishing treatments are well known techniques as a sintering technique of this kind of the precious metal containing clay compound. The pickling treatment is conducted by immersing the resulting sinter in a solution of a solid acid material for pickling, such as sodium hydrogen sulfate (commercially available product) or dilute sulfuric acid for about 5 min. Then, depending on the necessity, the resulting sinter is polished by a brush or the like and washed immediately with water. In the polishing treatment, since a variety of polishing tools such as a polishing spatula, a thread buff, Leutor, a sponge polishing material, and a stainless-steel brush are commercially available, these tools are appropriately selected and used for polishing.

### EXAMPLE

### Example 1

### Production of Decorative Metallic Article with Wood Grain Metal Pattern

<Materials Used>

A plastic copper containing clay compound was made composing of pure copper powder, and prepared as a mixed copper powder by mixing a first copper powder with a mean particle diameter of 2.5 μm in 50 wt % (or 45 wt % of the total material weight) and a second copper powder with a mean particle diameter of 10 μm in 50 wt % (or 45 wt % of the total material weight). Then, the mixed copper powder in 90 wt %, methylcellulose in 1.20 wt % and sodium carboxymethylcellulose in 0.30 wt % as organic binders, and water in 8.50 wt % were sufficiently mixed to produce a clay-like plastic copper containing composition.

A plastic silver containing clay compound was made composing of pure silver powder, and prepared as a mixed silver powder by mixing a first silver powder with a mean particle diameter of 2.5 μm in 50 wt % (or 46 wt % of the total material weight) and a second silver powder with a mean particle diameter of 20 μm in 50 wt % (or 46 wt % of the total material weight). Then, the mixed silver powder in 92 wt %, cellulose in 0.8 wt % and starch in 0.7 wt % as organic binders, and water as the remainder thereby to form a water soluble binder, were sufficiently mixed to produce a clay-like plastic silver containing clay compound.

(Plate Forming Step)

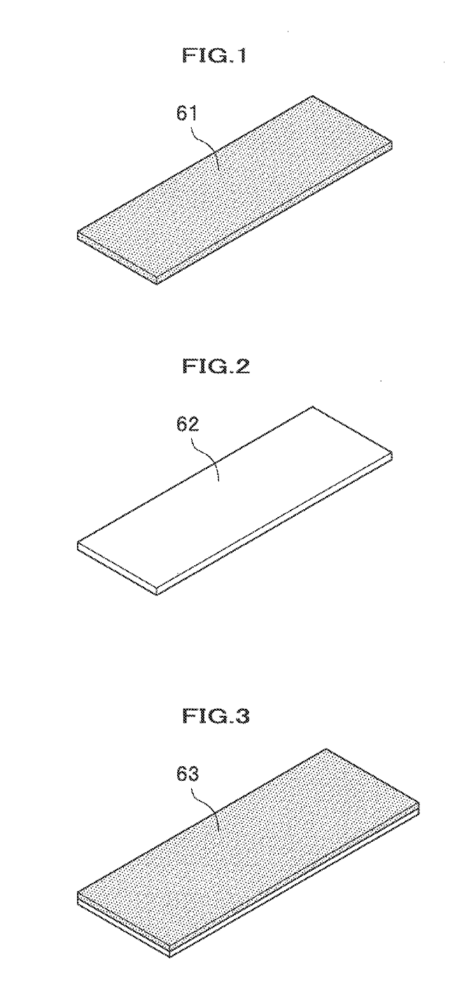

The above mentioned plastic copper containing clay compound and the plastic silver containing clay compound were separately wrapped in sheets made of resin, and the wrapped compounds were crumpled by hands about 30 times respectively to be softened. The softened plastic copper containing clay compound and the plastic silver containing clay compound were formed in straw bag shapes with each size comprising a diameter of about 10 mm and a height of about 20 mm, respectively. The plastic copper containing clay compound and the plastic silver containing clay compound, formed in straw bag shapes, were elongated by a roller to have each thickness of 2.0 mm, thereby to obtain a copper plate 61 and a silver plate 62 with each size comprising a width of about 20 mm and a length of about 50 mm (see FIGS. 1 and 2).

(Multi Layering and Adhesion Step)

After water was thinly applied to the silver plate using a paint brush, the copper plate was laminated on the water applied surface of the silver plate. The laminated copper-silver plate was flatly elongated by a roller so that the thickness of the laminated copper-silver plate became about 3.0 mm from about 4.0 mm, to obtain a copper-silver plate 63 adhering mutually (see FIG. 3).

The copper-silver plate 63 after mutually adhering was substantially halved in the parallel direction of the width direction. When the two pieces of the plate thus obtained were laminated and adhered each other, similarly to the above mentioned method, water was applied to contacting surfaces of the two pieces of the plate by using a paint brush, and further the two pieces of the plate were laminated so that the copper plate and the silver plate were mutually arranged. In such a state, the laminated copper-silver plate was flatly elongated by a roller to mutually adhere so that the thickness of the four layers of the laminated copper-silver plate became about 4.0 mm from about 6.0 mm.

Similarly, the four layered plate thus obtained was substantially halved by cutting it. When the two pieces of the plate was laminated to mutually adhere, similarly to the above mentioned method, water was applied to the contacting surfaces of the two pieces of the plate by using a paint brush, and further the two pieces of the plate were laminated so that the copper plate and the silver plate were mutually arranged. In such a state, the laminated copper-silver plate was flatly elongated by a roller to mutually adhere so that the thickness of the eight layers of the laminated copper-silver plate became about 5.0 mm from about 8.0 mm. Accordingly, was obtained a multi layered plate having eight layers comprising four layers of the copper plate and four layers of the silver plate adhering mutually.

(Wood Grain Metal Forming Step)

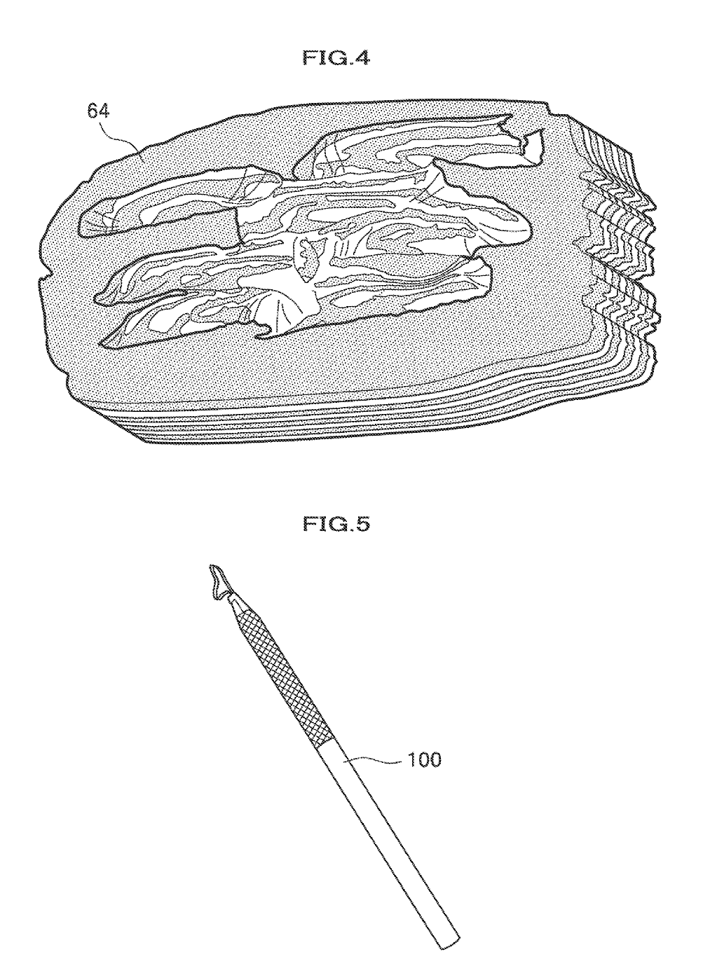

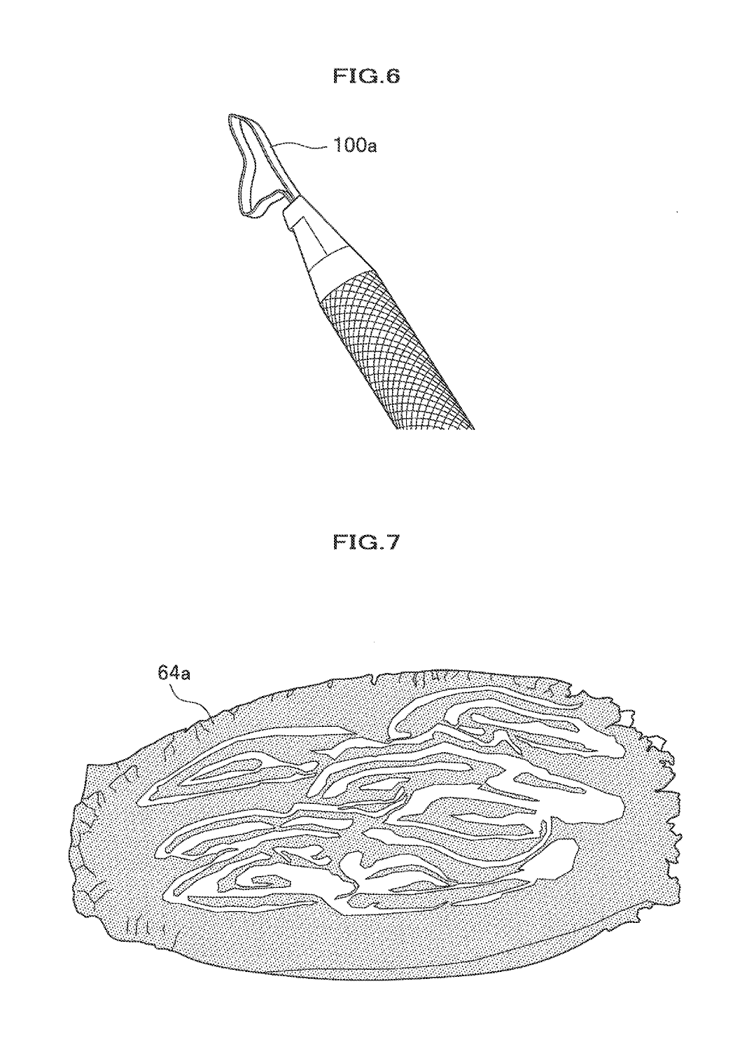

The surface of the multi layered plate thus obtained was carved by a plane 100 so as to expose a part of the copper plates and the silver plates as shown in FIG. 4. When looking at the carved multi layered plate 64 from above, various surfaces of the plates including a copper plate that was not carved located at the top of the multi layered plate, a silver plate exposed by carving the above mentioned copper plate, and another copper plate located at the lower layer exposed by carving the above mentioned silver plate, were exposed to appear as a wood grain metal pattern. A depth cut by a plane 100 was up to about 2.5 mm. Further, the plane 100 used in the step was the plane set of aluminum metal working (ISEKYU Co., Ltd.). Here, FIG. 6 is an expanded diagram showing the tip portion 100a of the plane 100 shown in FIG. 5.

Next, the above mentioned multi layered plate exposing a wood grain metal pattern was elongated (or extended) by a roller so that the thickness of the plate became about 2 mm, thereby to form a wood grain metal plate with a wood grain metal pattern 64a as shown in FIG. 7. The above mentioned operation flattened the carved surface of the plate.

(Decorative Object Forming Step and Decorative Object Drying Step)

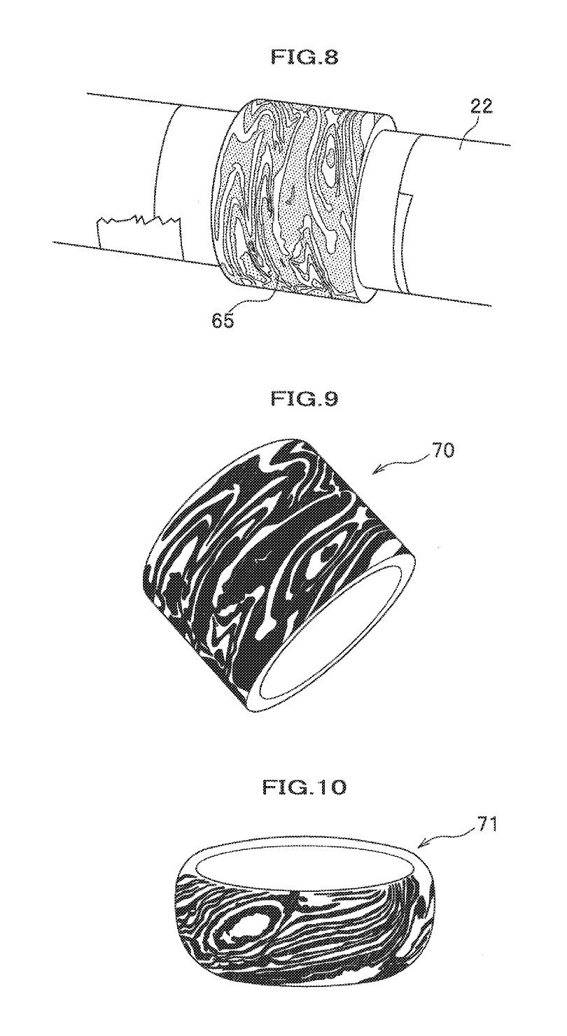

Both end portions of the wood grain metal plate were cut in the longitudinal direction of the wood grain metal plate to arrange the shape, thereby to obtain a substantially rectangular shaped wood grain metal plate. The wood grain metal plate thus obtained was rolled up to a wood shaft 22 as shown in FIG. 8, and dried, thereby to obtain a dried decorative object with a wood grain metal pattern in a ring shape 65. Note when the wood grain metal plate was rolled up to the wood shaft 22, a paper was put between the wood shaft 22 and the decorative object before drying it, so that the wood grain metal plate and the wood shaft 22 did not adhere together.

(Sinter Producing Step)

The dried decorative object 65 after drying it was taken off from the wood shaft 22, placed on a board made of fire resistance ceramic fibers (trade name: Kaowool Board), and sintered in the air in an electric furnace. Regarding the air sintering conditions, after the dried decorative object 65 was put in an electric furnace, the temperature inside the furnace was heated up to 450° C. from room temperature, and then the decorative object was immediately taken out from the electric furnace.

Next, charcoal was put in an altaite vessel to form a bed thereof, and the air sintered decorative object was embedded under the upper surface of the charcoal in a depth of about 1 cm. Then, the altaite vessel was sealed. Next, the altaite vessel was put in the electric furnace, heated until the temperature inside the furnace reached 780° C. from room temperature, and the temperature was kept for 8 hrs (that is, sintering in the reduction atmosphere). After 8 hrs, a sinter was taken out from the furnace, and cooled in the air. Then, after cooling, the surface of the sinter was polished. FIG. 9 shows a decorative object sinter 70 thus finally obtained. The ring shaped decorative metallic article with the wood grain metal pattern (or ring) 70 comprises a copper part shown in a black color and a silver part shown in a white color. As shown in FIG. 9, the method for producing the decorative metallic article with the wood grain metallic pattern of the present invention was able to form the wood grain metal pattern clearly and gorgeously.

### Example 2

### Production of Decorative Metallic Article with Wood Grain Metal Pattern

After drying and before sintering, a decorative object sinter was produced in the same method as in Example 1 except that the both end corners of the wood grain metal plate in the substantially rectangular parallel-piped shape thus obtained above was scraped by sandpaper, thereby to arrange the shape thereof so that the cross-section in the vertical direction of the longitudinal direction has a rounded shape. Then, the surface of the decorative sinter was polished. FIG. 10 shows a finally obtained decorative metallic article 71. Similarly to FIG. 9, a black region represents a copper part and a white region represents a silver part. As shown in FIG. 10, according to the method for producing the decorative article with the wood grain metal pattern of the present invention, the wood grain metal pattern may be clearly and gorgeously formed.

### Example 3

### Production of Decorative Copper-Silver Metallic Article with Wood Grain Metal Pattern

A mixed copper powder in 90 wt % [composition of the mixed powder by weight: a copper powder (made of pure copper) in 47.5 wt % with a mean particle diameter of 2.5 μm and another copper powder (made of pure copper) in 47.5 wt % with a mean particle diameter of 10 μm, zirconium oxide in 5.0 wt %], and as organic binders, methylcellulose in 1.20 wt % and hydroxypropylmethyl-cellulose in 0.15 wt %, starch in 0.8 wt %, lignin in 0.10 wt %, and water in 7.75 wt %, were sufficiently mixed to prepare a plastic copper containing clay compound.

In the meantime, a plastic silver containing clay compound was prepared as in the completely same method of Example 1, by sufficiently mixing a mixed silver powder in 92 wt % [composition of the mixed powder by weight: a first silver powder (made of pure silver) in 50 wt % with a mean particle diameter of 2.5 mm and a second silver powder (made of pure silver) in 50 wt % with a mean particle diameter of 20 μm], and a water-soluble binder including starch in 0.7 wt %, cellulose in 0.80 wt % as organic binders, and the remainder of water.

Then, a decorative metallic article with two kinds of wood grain metal patterns was produced same as in Examples 1 and 2 except that the above mentioned materials were used as the clay-like plastic copper containing clay compound and the clay-like plastic silver containing clay compound. As a result, the wood grain metal pattern was able to be formed clearly and gorgeously, in the same manner as the decorative metallic article with the wood grain metal pattern (not shown) produced in Examples 1 and 2.

### DESCRIPTION OF REFERENCE NUMERALS

70 Decorative metallic article with wood grain metal pattern (or ring)
71 Decorative metallic article with wood grain metal pattern (or ring) in another Example

1. A method for producing a decorative metallic article with a wood grain metal pattern comprising:
a plate forming step of forming a plastic copper containing clay compound including an organic binder and at least one kind of a copper powder metal selected from copper and a copper alloy, and a plastic silver containing clay compound including an organic binder and at least one kind of a silver powder metal selected from silver and a silver alloy, into plate-like shapes respectively, thereby to produce a copper plate and a silver plate;
a multi layering and adhesion step of applying water to joint surfaces of the copper plate and the silver plate, to mutually laminate the plates one another, and adding a lord on laminated plates to be elongated so that a thickness of the laminated plates decreases in 10% or more, thereby to adhesively paste the laminated plates each other;
a wood grain metal plate forming step of carving a surface of a multi layered plate produced in the multi layering and adhesion step so as to expose at least a part of the copper plates and the silver plates, and elongating a carved surface of the multi layered plate to become flat, thereby to form a wood grain metal pattern;
a decorative object forming step of forming the decorative object with a wood grain metal pattern by using the formed wood grain metal plate;
a decorative object drying step of drying the formed decorative object with the wood grain metal pattern; and
a sinter producing step of sintering the dried decorative object produced in the decorative object drying step so as to obtain a decorative object sinter.

2. The method for producing a decorative metallic article with a wood grain metal pattern as described in claim 1, the multi layering and adhesion step comprising the processes of:
applying water to joint surfaces of the copper plate and the silver plate, to mutually laminate the plates one another,
adding a lord on laminated plates to elongate the laminated plates so that a thickness of the laminated plates decreases in 10% or more, thereby to adhesively paste the laminated plates together for forming a copper-silver plate;
further cutting or folding back the copper-silver plate;
applying water to joint surfaces of the resulting copper-silver plate to mutually laminate the plates one another;
adding a lord on laminated plates to elongate the laminated plates so that a thickness of the laminated plates decreases in 10% or more, thereby to adhesively paste the laminated plates together for obtaining a multi layered copper-silver plate;
repeating the first applying water process to the last adding a load process at least one time for obtaining the multi layered copper-silver plate.

3. The method for producing a decorative metallic article with a wood grain metal pattern as described in claim 1, the multi layering and adhesion step comprising a process of elongating the laminated plates so that a thickness of the laminated plates decreases in 20 to 80% so as to adhesively paste the laminated plates together.

4. The method for producing a decorative metallic article with a wood grain metal pattern as described in claim 1, the decorative object forming step further comprising a process of shaping the wood grain metal plate into a ring shaped object to form a ring with a wood grain metal pattern.

5. The method for producing a decorative metallic article with a wood grain metal pattern as described in claim 1, the decorative object drying step comprising a process of natural drying or heat drying at a drying temperature of 80 to 180° C. and with a drying time for 10 to 60 min.

6. The method for producing a decorative metallic article with a wood grain metal pattern as described in claim 1, the sinter producing step comprising the processes of: taking out the decorative object from a heat source immediately after a firing temperature in the air reaches 350 to 450° C. from room temperature; sintering the decorative object in the reduction atmosphere, heated up to 700 to 800° C. from room temperature; and keeping the temperature for 30 min to 9 hr.

7. The method for producing a decorative metallic article with a wood grain metal pattern as described in claim 1, the whole sinter producing step being conducted in the air.

8. The method for producing a decorative metallic article with a wood grain metal pattern as described in claim 7, the sinter producing step being conducted at a sintering temperature of 660 to 770° C. and in a sintering time for 3 to 40 min.

9. The method for producing a decorative metallic article with a wood grain metal pattern as described in claim 8,
at least one kind of the copper powder metal selected from copper and a copper alloy included in the plastic copper containing clay compound being a mixed copper powder consisting of a first copper powder with a mean particle diameter of 0.1 to 4.0 μm in 25 to 75 wt %, and the remainder of a second copper powder with a mean particle diameter in the range from more than 4.0 μm to 10 μm or less; and
at least one kind of the silver powder metal selected from silver and a silver alloy included in the plastic silver containing clay compound being a mixed silver powder consisting of a first silver powder with a mean particle diameter of 0.1 to 4.0 μm in 25 to 75 wt %, and the remainder of a silver second powder with a mean particle diameter in the range from more than 4.0 μm to 40 μm or less.

10. A decorative metallic article with a wood grain metal pattern, the decorative metallic article being produced by the method as described in claim 1.
